(19) United States
(12) Patent Application Publication
(10) Pub. No.: US 2024/0330258 A1
(43) Pub. Date: Oct. 3, 2024

(54) METHOD, APPARATUS, ELECTRONIC DEVICE, AND STORAGE MEDIUM OF DATA MANAGEMENT

(71) Applicant: Beijing Volcano Engine Technology Co., Ltd., Beijing (CN)

(72) Inventors: Lei ZHAO, Beijing (CN); Zhe LUO, Beijing (CN); Xuan LUO, Beijing (CN)

(21) Appl. No.: 18/615,927

(22) Filed: Mar. 25, 2024

(30) Foreign Application Priority Data
Mar. 30, 2023 (CN) 202310331251.7

(51) Int. Cl. G06F 16/21; G06F 16/215; G06F 16/23

(52) U.S. Cl. CPC G06F 16/217; G06F 16/215; G06F 16/2358

(57) ABSTRACT

The present disclosure provides a method, apparatus, electronic device and storage medium of data management. The method comprises: in accordance with a determination that data specification information does not match target data comprised in editable information, determining a target data modification message; and pushing the target data modification message to a target collaborative user device, so as to cause a target user to modify the target data through the target collaborative user device; wherein the target data modification message comprises locating information of the target data, and the target collaborative user device is determined based on the locating information. At this point, the maintenance user of the target data may obtain the target data modification message through the target collaborative user device in time and further modify the target data based on the target data modification message.

### CROSS-REFERENCE

The present application claims priority to Chinese Patent Application No. 202310331251.7, filed on Mar. 30, 2023, and entitled “METHOD, APPARATUS, ELECTRONIC DEVICE, AND STORAGE MEDIUM OF DATA MANAGEMENT”, the entirety of which is incorporated herein by reference.

### FIELD

The present disclosure relates to the field of computer technology, and in particular, to a method, apparatus, electronic device and storage medium of data management.

### BACKGROUND

In the continuous growth and diversification of business, most enterprises use some data systems to drive their development; and in order to better manage the enterprise and smooth the flow of internal information in the enterprise, the enterprise will adopt a collaborative office system to facilitate information exchange between users.

In the related art, data is usually managed hierarchically and classified based on the concept of process management. Many companies will specially set up technical departments composed of technical users to manage data. However, people who use data might belong to different departments. Communication between users in different departments will lead to misunderstandings and inefficiencies. Therefore, simple data management can only address data orderliness, but cannot solve the problem of synergies in the application of data.

### SUMMARY

According to one aspect of the present disclosure, a method of data management is provided, the method comprising:
in accordance with a determination that data specification information does not match target data comprised in editable information, determining a target data modification message; and
pushing the target data modification message to a target collaborative user device, so as to cause a target user to modify the target data through the target collaborative user device;
wherein the target data modification message comprises locating information of the target data, and the target collaborative user device is determined based on the locating information;
the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data structure maintenance user.

According to another aspect of the present disclosure, an apparatus of data management is provided, the apparatus comprising:
a determining module configured for, in accordance with a determination that data specification information does not match target data comprised in editable information, determining a target data modification message; and
a pushing module configured for pushing the target data modification message to a target collaborative user device, so as to cause a target user to modify the target data through the target collaborative user device; wherein the target data modification message comprises locating information of the target data, and the target collaborative user device is determined based on the locating information; the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data structure maintenance user.

According to another aspect of the present disclosure, an electronic device is provided, comprising:
a processor; and
a memory for storing a program;
wherein the program comprises instructions, which, when executed by the processor, cause the processor to perform a method according to the example embodiments of the present disclosure.

According to another aspect of the present disclosure, a non-transient computer-readable storage medium is provided storing computer instructions thereon, wherein the computer instructions are configured for causing a computer to perform a method according to the example embodiments of the present disclosure.

With one or more technical solutions provided in the example embodiments of the present disclosure, if it is detected that the data specification information does not match the target data included in the editable information, the target data modification message is pushed to the target collaborative user device, so as to cause the target user to modify the target data through the target collaborative user device. The target data modification message includes the locating information of the target data, and the target collaborative user device is determined by the locating information. Therefore, the maintenance user of the target data can obtain the target data modification message through the target collaborative user device in a timely manner, and then modify the target based on the target data modification message. data. The editable information includes editable shared information from a plurality of collaborative user devices; the editable shared information includes data structures and data contents maintained by different maintenance users. If the target data is data of data structure type, the target user of the target collaborative user device is a data structure maintenance user; if the target data is data of data content type, the target user of the target collaborative user device is a data structure maintenance user. Based thereon, the time required in the information transfer process can be reduced, collaboration efficiency improved, and data accuracy guaranteed.

### BRIEF DESCRIPTION OF THE DRAWINGS

More details, features and advantages of the present disclosure are disclosed in the following description of example embodiments taken in conjunction with the accompanying drawings, in which:

FIG. 1 shows a schematic diagram of an example system in which various methods described herein may be implemented according to example embodiments of the present disclosure;

FIG. 2 shows a basic flowchart of a method of data management according to example embodiments of the present disclosure;

FIG. 3 shows a schematic diagram of a master data cataloging document according to example embodiments of the present disclosure;

FIG. 4 shows a schematic diagram of a master data cataloging standard document according to example embodiments of the present disclosure;

FIG. 5 shows a schematic block diagram of modules of an apparatus of data management according to example embodiments of the present disclosure;

FIG. 6 shows a schematic block diagram of a chip according to example embodiments of the present disclosure; and

FIG. 7 shows a structural block diagram of an example electronic device which can be used to implement embodiments of the present disclosure.

### DETAILED DESCRIPTION

The embodiments of the present disclosure will be described in more detail below with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below. Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

Before introducing the embodiments of the present disclosure, first of all, the relevant terms involved in the embodiments disclosed herein are explained as follows:

A target collaborative user device refers to a program that corresponds to a data management platform and that provides local services to users.

Data management is the process of effectively collecting, storing, processing and applying data using computer hardware and software technology. The purpose is to make full and effective use of data, and the key to effective data management is data organization.

Master data refers to data shared between systems (for example, data related to clients, suppliers, accounts, and organizational units). Compared with transaction data that records business activities and fluctuates greatly, master data (also called baseline data) changes slowly. In a formal relational data model, transaction records (for example, order line items) can call master data by keywords (for example, order header or invoice number and product code). Master data must exist and be properly maintained to ensure the referential integrity of the transaction system.

Structured Query Language (SQL) is a database query and programming language used to access data and query, update and manage relational database systems.

Database is a data management system for business intelligence activities. It is only suitable for query and analysis and usually involves a large amount of historical data. In practical applications, the data in the database generally comes from a wide range of sources such as application log files and transaction applications. Databases can centralize and integrate large amounts of data from a plurality of sources. With the analysis capabilities of databases, enterprises can gain valuable business insights from data and improve decision-making. Meanwhile, over time, a historical record will be built that is extremely valuable to data scientists and business analysis users. Thanks to these powerful features, databases can provide enterprises with a “single source of information.”

Data asset management is a management concept for intangible assets proposed in recent years, which capitalizes data and manages data at hierarchies and categories through quantification, control, realization and other dimensions. In the prior art, data management mainly relies on software or database systems for management, and there are also relevant evaluation standards for data management maturity. Master data is part of data assets and is mainly used to characterize the main line data of the company's core business. It emphasizes the data integration, connection and sharing of various business departments, and establishes a data standard system that can be shared by various business departments. Moreover, in addition to being data assets, master data is more about completing data sharing and the construction of data standards among various departments. Whether to share the cataloging of master data and standardization needs to be set with the participation of various departments. Currently, most software products are operated through an independent web page system, which, like an independent filling system, is not associated with the daily business work and has poor collaboration.

The existing data management work is relatively technical and far away from specific business, and technical users of data management need to have relevant technical backgrounds, and the division of labor between business and technology in the prior art will bring the cost of understanding at the boundary between business and technology. With the development of data services, the corresponding cost of understanding gets increasingly high. It is difficult to cultivate people who understand both business and technology. When there is a problem with the data, technical users need to notify the corresponding users to make changes to the data. The information loss and collaboration efficiency are low, and the research and development cost of data work is relatively high. After the data is changed, if all operations are handed over to technical users, the cost will be high.

In the related art, data is first hierarchically classified. Based on the concept of data process management, step-by-step management is carried out from the steps of data generation, processing, transformation, storage, sharing and destruction. Further, a data management department composed of technical users of data management performs unified management of data. During the specific operation process, technical users first need to identify target data in question, then determine relevant users related to the content of the target data, then notify the relevant users to modify the target data, and update data in the database based on the modified target data. In this process, technical users are professional users of data management, but in practical applications, the same data may be used by people with multiple different roles. When problems occur with the data, communication can only be carried out through the basic information transfer process. However, technical users, only as technical users of data management, do not know the specific content of the data. At this point, when the technical users notify relevant users to modify the data, a waste of time may be caused, and the efficiency is low due to unclear communication. Further, in the process of data process management, simple data management can only address the problem of data orderliness and cannot improve collaboration efficiency.

In view of the above problems, an example embodiment of the present disclosure provides a method of data management, which relies on a data management platform to realize online information sharing in place of data management products. When an exception occurs to data, a target data modification message is delivered to a target collaborative user device through the data management platform, so that a maintenance user of the target data can modify the target data in time when reminded by the target data modification message, thereby reducing the time waste caused in the process of information transfer and improving collaboration efficiency.

The method of data management provided by the example embodiment of the present disclosure can be applied in various collaborative scenarios based on instant messaging. FIG. 1 shows a schematic diagram of an example system in which various methods described herein may be implemented in accordance with an example embodiment of the present disclosure. As shown in FIG. 1, the application scenario 100 of the example embodiment of the present disclosure comprises a first target collaborative user device 110, a second target collaborative user device 120, a third target collaborative user device 130, a data management platform 140 and a database 150.

In practical applications, as shown in FIG. 1, the first target collaborative user device 110, the second target collaborative user device 120, and the third target collaborative user device 130 all support online document editing, group chat, automatic message sending, task functions configuration and application program interfaces. It should be understood that the collaborative user device here can be any instant messaging platform.

The collaborative user devices installed on the first target collaborative user device 110, the second target collaborative user device 120 and the third target collaborative user device 130 may be the same type of application programs based on the same or different operating system platforms (Android, Huawei Hongmeng system, etc.,). The first target collaborative user device 110 may be a data content maintenance terminal, the second target collaborative user device 120 may be a data structure maintenance terminal, and the third target collaborative user device 130 may be a data management terminal, wherein the first target collaborative user device 130 may be a data management terminal. The number of the first target collaborative user device 110, the second target collaborative user device 120, and the third target collaborative user device 130 may be one or multiple, depending on the actual application scenario. The example embodiments of the present disclosure are only illustrated taking the first target collaborative user device 110, the second target collaborative user device 120, and the third target collaborative user device 130 by way of example. The device types of the first target collaborative user device 110, the second target collaborative user device 120 and the third target collaborative user device 130 are the same or different, and the device types include: at least one of smart phones, tablet computers, laptop computers and desktop computers.

As shown in FIG. 1, the above-mentioned first target collaborative user device 110, second target collaborative user device 120, and third target collaborative user device 130 can communicate with the data management platform 140 through a communication network. In terms of communication methods, communication networks can be divided into wireless communication networks, such as satellite communications, microwave communications and the like, or wired communication networks, such as optical fiber communications and power line carrier communications; in terms of communication scope, communication networks can be local area communication networks, such as Wifi, Zigbee communication networks, etc., or may be wide-area communication networks, such as the Internet network.

As shown in FIG. 1, the above-mentioned data management platform 140 can be a server, a server cluster composed of a plurality of servers, or a distributed system, or it can be a cloud server that provides cloud services, cloud databases, cloud computing, cloud functions, cloud storage, network services, cloud communications, middleware services, domain name services, security services, Content Delivery Network (CDN), and big data and artificial intelligence platforms and other basic cloud computing services. The database 150 can be a general term that includes local storage and databases storing historical data. The database 150 may be separate from the data management platform 140 or integrated within the data management platform 140.

In practical applications, the user corresponding to the first target collaborative user device 110 is a first user, and the first user is a data content maintenance user; the user corresponding to the second target collaborative user device 120 is a second user, and the second user is a data structure maintenance user. The user corresponding to the third target collaborative user device 130 is a third user, and the third user is a management user of database data information. The first user, the second user and the third user can log in to the data management platform by entering their user names and passwords through the first target collaborative user device 110, the second target collaborative user device 120 and the third target collaborative user device 130 respectively. The platform verifies the user's identity by reading the user database. If the user name and password are correct, a sign that the user has successfully logged in will be displayed. Then, corresponding data editing permissions are configured for the first user, the second user, and the third user. It is possible for a plurality of users to jointly maintain whole data in an efficient and collaborative manner based on the corresponding data editing permissions.

The first user may perform data content maintenance on editable information through the first target collaborative user device 110, which updates the editable information in the data management platform 140 based on the maintenance operation of the first user on the editable information; the second user can perform data structure maintenance on the editable information through the second target collaborative user device 120, which updates the editable information in the data management platform 140 based on the maintenance operation of the second user on the editable information; the third user can manage the database data information through the third target collaborative user device 130, which updates the corresponding data information in the data management platform based on the maintenance operation of the third user on the database data information; meanwhile, the first target collaborative user device 110, the second target collaborative user device 120 and the third target collaborative user device 130 send all data information to the data management platform 140, and the data management platform 140 compares whether the data specification information matches the target data in the editable information, and instructs corresponding target maintenance people to main unmatched target data through the collaborative user device. Moreover, the data management platform 140 is connected to the database 150, and compares the database 150 with data specification information, and instructs corresponding target maintenance people to maintain the unmatched target data through the collaborative user device.

The steps performed by the data management platform of the example embodiment of the present disclosure can also be performed by a chip applied in the collaboration platform, and the steps performed by a data detection tool can also be performed by a chip applied in the data detection tool. The solution of the example embodiment of the present disclosure will be described by taking the data management platform as an execution body.

FIG. 2 shows a basic flowchart of a method of data management of an example embodiment of the present disclosure. As shown in FIG. 2, the method of data management of the example embodiment of the present disclosure may comprise:

Step 201: in accordance with a determination that data specification information does not match target data comprised in editable information, determining a target data modification message, wherein, the target data modification message at least comprises abnormal information of the target data, which may be the target data missing, the target data being damaged, the target data being incorrect and other modification to abnormal information.

As an example, the data management platform obtains data specification information from at least one collaborative user device, and a user of the collaborative user device is a data specification information maintenance user. It should be understood that the data management platform may comprise a collaboration platform and a data detection tool. Based thereon, the collaboration platform may first obtain data specification information from the collaborative user device, and then forward the data specification information to the data detection tool.

For example, the data specification information maintenance user may log in to the collaborative user device and create and edit data specification information on the collaborative user device to standardize the data structure and data content. When the editing of the data specification information is completed and saved, the data specification information may be synchronized to the data management platform; at the same time, data transmission may be performed by establishing a data access interface between the data management platform and the collaborative user device, so that the data management platform can obtain the data specification information sent by the collaborative user device, based on the data access interface.

In practical applications, when the data management platform obtains the data specification information sent by the collaborative user device, since the data specification information is used to standardize the data structure and data content, the detected data specification information may be matched with data information contained in the editable information. If it is detected that the data information contained in the editable information does not match the data specification information, unmatched target data is determined, and the target data modification message is determined. Then the data management platform performs step 202. If there is a match, a message that the target data is matched successfully is generated based on a matching result, and then the message that the target data is matched successfully is sent to the collaborative user device.

Step 202: pushing the target data modification message to a target collaborative user device, so as to cause a target user to modify the target data through the target collaborative user device.

For example, if the data specification information does not match the target data comprised in the editable information, the data management platform may push the target data modification message to the target collaborative user device based on the target data modification message. Since user information of the target collaborative user device contains the maintenance user information of the target data, the target data modification message may be sent directly to the target collaborative user device used by the maintenance user of the target data through the data management platform, thereby reducing the message transfer process and improving the efficiency of collaborative work.

In an optional manner, the data specification information of the example embodiments of the present disclosure may comprise a data structure specification and further a data content specification. The data structure specification is used for data naming of the editable information, and the data content specification is mainly used to standardize data integrity of the editable information, such as predetermined fields of data content. Considering that the editable data comes from various sources, which might be editable shared information created through the target collaborative user device or might come from a database, the example data structure specification of the present disclosure may be data specification programming information. The required data structure specification and data content specification may be extracted from the data specification programming information, and data detection may be performed on the editable shared information, but can data content from the database maintained by technical users may be compared directly using the data specification programming information. It can be seen that with the method of the example embodiments of the present disclosure, By comparing the data content, it can be seen that the example embodiment method of the present disclosure, a comparison bridge may be established between the editable shared information and the data content from the database through the data specification programming information to ensure strict matching therebetween, thereby reducing collaboration.

When the editable information is the editable shared information, a plurality of editable shared information may be created on the data management platform through the collaborative user devices. The relevant maintenance users may edit the plurality of editable shared information based on the collaborative user devices, to synchronize the data to the data management platform. The plurality of editable shared information of the example embodiments of the present disclosure may comprise a master data cataloging document and a master data cataloging standard document. Among them, the types of the master data cataloging document and the master data cataloging standard document may be, but not limited to, Excel type, word type, txt type, etc. It should be understood that the same editable shared information might be maintained by a plurality of different maintenance users. Therefore, the plurality of maintenance users corresponding to the same editable shared information may be invited to the same group, the permissions for editable shared information are opened for the plurality of different users. When a maintenance user edits an editable shared document, a message notification is sent to other maintenance users based on a message push window to facilitate timely communication. Optionally, a shared dashboard may be set in the data management platform, and the content in the editable shared information may be displayed to other maintenance users for reference.

In practical applications, the same editable shared information might need to be maintained by a plurality of maintenance users with different roles from different perspectives. For example, the example embodiments of the present disclosure divide the plurality of maintenance users with different roles into three major categories, including data users, data architects, and technical users. Among them, data users may be business users who use data but do not have the conditions for data research and development, but are clear about data assets and data standards; data architects may be people who understand the business framework, have the ability to plan the data architecture, and can edit the format of shared information and provide constructive advice on the structure of databases; technical users refer to data research and development people and people with the ability of data processing, computation and development, who have the ability to fill data into the database and maintain the data in the database.

Data architects mainly design the data structure of the framework of master data cataloging documents and master data cataloging standard documents and maintain the content of data specification information, while data users mainly maintain the content in master data cataloging documents and master data cataloging standard documents; technical users mainly maintain the data content in the database, e.g., may supplement missing data to the database.

It can be seen that when the editable information comprises editable shared information from a plurality of collaborative user devices, the editable shared information may comprise data structures and data contents maintained by different maintenance users, wherein the data structure of the editable shared information is mainly designed by data architects, and the data content of the editable shared information is mainly maintained by data users. When the editable information comprises data information from the database, the data information is maintained by technical users.

For example, if the target data is data of data structure type, the target user of the target collaborative user device is a data structure maintenance user. Therefore, when the collaborative user device obtains the target data modification message from the data management platform, the data architect may modify the target data based on the target data modification message by using the target collaborative user device.

If the target data is data of data content type, the target user of the target collaborative user device is a data structure maintenance user. Therefore, when the collaborative user device obtains the target data modification message from the data management platform, the data user may modify the target data based on the target data modification message by using the target collaborative user device.

When the target data is the data content from the database, the user editable shared information in the data management platform may be the data information in the database. When the target data is the data content from the database, the user information of the target collaborative user device may essentially comprise user information of the technical user. Therefore, when the collaborative user device obtains the target data modification message from the data management platform, the technical user may modify the target data based on the target data modification message by using the target collaborative user device.

Based thereon, with the example embodiments of the present disclosure, centralized data management products are replaced with decentralized daily tasks, the data management products are integrated into the data management platform, requirements are unidirectionally transferred from business to technology, wherein respective tasks are completed by respective roles, and data is maintained in the form of online documents, thereby improving the collaborative office efficiency and reducing economic and time costs.

In an optional manner, when the data specification information comprises a data structure specification, when matching the data specification information and the editable information, the data management platform may match the data structure specification of the editable information and obtain a data structure matching result. If the data structure matching result is abnormal, the target data is determined based on the data structure matching result. Similarly, when the data specification information comprises the data content specification, when matching the data specification information and the editable information, the data content specification of the editable information can be matched to obtain a data content specification result. If the data content matching result is abnormal, the target data is determined based on the data content matching result. On this basis, the data management platform may push the target data modification message to the target collaborative user device.

As an example, the above-mentioned determining the target data modification message based on the target data comprises determining abnormal information of the target data based on the target data; and determining the target data modification message based on the abnormal information of the target data, wherein the target data modification message further comprises a modification prompt of the target data, and the modification prompt may be determined based on the abnormal information, and the user information is determined based on the maintenance user information of the target data.

For example, the abnormal information of the target data may include the error content of the target data, and may also include the cause of the error, etc. When the data management platform sends the target data modification message to the target collaborative user device, a maintenance user of the target data is determined based on the target data modification message, and then it is determined that the target user of the collaborative user device matches the maintenance user of the target data. Meanwhile, a modification prompt of the target data may further be sent through the data management platform, the modification prompt being pushed in the form of a target data modification message to the target collaborative user device that matches the maintenance user.

The above target data modification message also includes locating information of the target data, and the target collaborative user device may be determined by the locating information of the target data. When the data management platform detects that the target data does not match, it can also determine to which editable shared information the target data specifically belongs based on the locating information of the target data, and determine its location in the editable shared information. Based thereon, the data management platform can determine the maintenance user information based on the target data and determine the location of the target data.

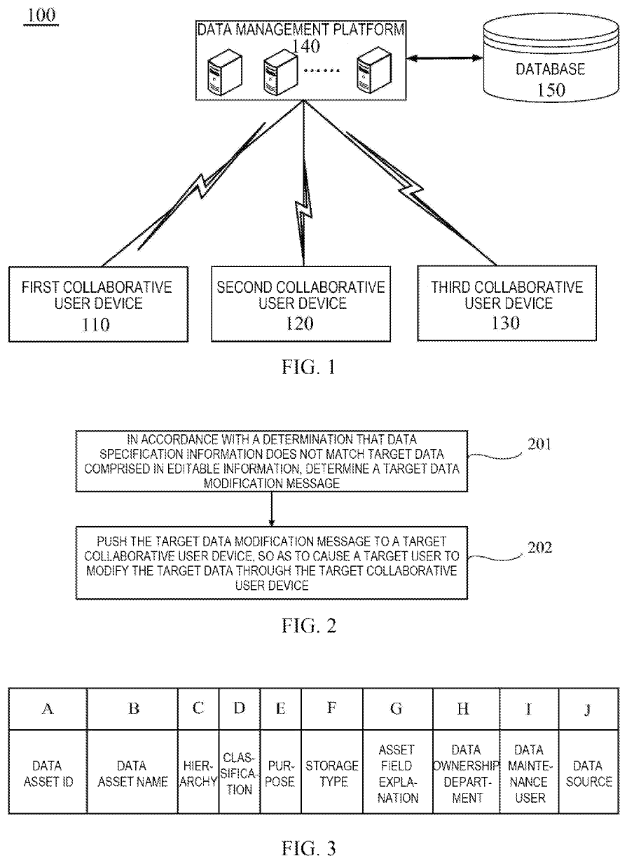

FIG. 3 shows a schematic diagram of a master data cataloging document according to an example embodiment of the present disclosure. As shown in FIG. 3, the master data cataloging document is mainly used to catalog the core content contained in the master data. For example, the header of the master data cataloging document may include data asset ID, data asset name, hierarchy, classification, purpose, storage type, asset field explanation, data ownership department, data maintenance user, and data source.

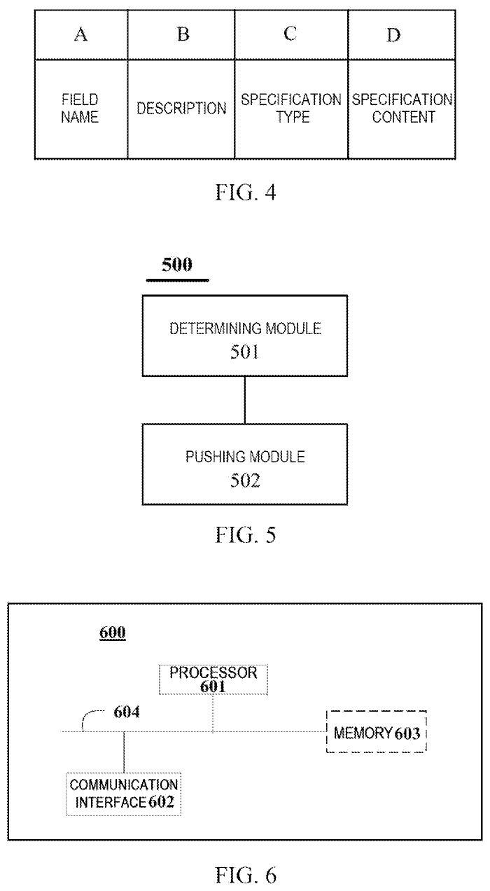

FIG. 4 shows a schematic diagram of a master data cataloging standard document according to an example embodiment of the present disclosure. As shown in FIG. 4, the master data cataloging standard document is mainly used to describe the data information contained in the corresponding directory document in the master data cataloging document. For example, the header of the master data cataloging standard document may include field name, description, specification type, and specification type. The data specification document is a document that converts the master data cataloging document and the master data cataloging standard document into an SQL language form.

When the editable information is the master data cataloging document, it matches the master data catalog document and the data specification information. If the data structure matching result is abnormal, the target data is determined based on the abnormal result. At this time, the target data can be considered as data naming, the target data modification message is pushed to the collaborative user device based on data management, and the maintenance user information to which the data structure belongs is determined based on the target data. At the same time, a target data modification message is sent to the collaborative user device of the maintenance user containing the target data. The target data modification message also includes locating information of the target data, and the maintenance user information can be determined by the locating information. Based thereon, the data user modifies the target data based on the target data modification message.

In practical applications, the master data cataloging document can be converted into a computer array structure, and then the master data cataloging document and data structure specification can be matched to obtain the data content matching result. If the data content matching result is abnormal, the target data will be determined based on the matching result. Then, based on a string approximation algorithm, the data catalogs with the same name in the master data cataloging document are filtered out, and the data catalogs with the same data content are determined based on the data catalogs with the same name. Data with both the same data catalogs and the same data contents are merged, data catalogs with different data contents in the same data catalog are re-edited, or corresponding remarks are added to distinguish them.

When the editable information is a master data cataloging standard document, the master data cataloging standard document and data specification information are matched. If the data content matching result is abnormal, the target data is determined based on the abnormal result. At this point, the target data can be considered as data integrity. The target data modification message is pushed to the collaborative user device based on the data management tool, and the maintenance user information corresponding to the target data is obtained based on the master data cataloging standard document, and the target data modification message is sent to the target collaborative user device of the maintenance user containing the target data. Based thereon, the data user modifies the target data based on the target data modification message.

In practical applications, the master data cataloging standard document can be converted into a computer array structure, and then the master data cataloging standard document and data structure specification and data content specification can be matched to obtain the data content matching result. If the data content matching result is abnormal, the target data is determined based on the matching result.

Considering that the data specification information is automatically generated from the data management platform, it might also be generated by manual editing in collaboration with the user device. Based thereon, the example embodiments of the present disclosure match the data content specification and a predetermined specification of the data specification information. If the data content specification of the data specification information does not match the predetermined specification, it is determined that the matching result is abnormal, and the target data contained in the data content of the data specification information is determined based on the matching result. It should be understood that the predetermined specification may be a predetermined content specification that already exists in the data management platform.

In order to ensure that the data specification information is accurate, the data specification information and the predetermined data content specification can also be matched. The predetermined data content specification can be considered as the specification content determined by the data user.

If the data content specification of the data specification information does not match the predetermined data content specification, it means that the data integrity is not enough. Therefore, it can be determined that the matching result is abnormal, the target data contained in the data content of the data specification information is determined based on the abnormal matching result, and the target data modification message is pushed to the target collaborative user device based on the target data, to notifying the maintenance user of the data specification information to modify the target data in the target collaborative user device based on the target data modification message.

For example, when a problem occurs in the data structure edited by the data architect, all contents related to the data structure need to be re-edited. At this point, the master data cataloging document, master data cataloging standard document and data specification information all need to be re-edited. The data information in the corresponding database also needs to be adaptively modified based on the modification to the data specification information.

In practical applications, when the data specification information is data specification programming information, incorrect use of a programming language may occur. Therefore, the programming language specification of the data specification programming information can be matched with the reference programming language. If the programming language specification of the data specification programming information does not match the reference programming language, it is determined that the matching result is abnormal, and the target data contained in the programming language of the data specification programming information is determined based on the abnormal matching result. It should be understood that the predetermined specification may be a predetermined content specification that already exists in the data management platform.

The above target data can be programming statements with programming language syntax errors. When the target data modification message is pushed to the collaborative user device based on the data management tool, and the maintenance user information corresponding to the target data is obtained based on the master data cataloging standard document, the target data modification message is sent to the target collaborative user device of the maintenance user containing the target data. Based thereon, the maintenance user modifies the target data based on the target data modification message. Here, since there is only a language problem that has little impact on the substantive data content, only the incorrect programming statements need to be changed, and other related data information does not need to be modified.

Based thereon, for the data specification programming information, first the data asset items contained in data specification programming information need to be identified, and the data specification programming information is converted into a computer array structure, and the programming language specification of the data specification programming information is matched with the reference programming language. If the programming language specification of the data specification programming information does not match the reference programming language, it is determined that the matching result is abnormal, and the target data contained in the programming language of the data specificat ion information is determined based on the matching result. Next, the data names with the same names in data specification programming information are filtered out based on the string approximation algorithm, the data names with the same data content are determined based on the data with the same names, data with both the same data content and the same data naming is merged, data naming with different data contents in the same data naming is re-edited, or corresponding remarks are added to distinguish; at the same time, the data content specification of the data specification programming information is matched with a predetermined specification, it is determined that the matching result is abnormal, and the target data contained in the data content of the data specification information is determined based on the matching result. It should be understood that the reference programming language can be a standard SQL statement and contain corresponding information in the master data cataloging document and the master data cataloging standard document.

The editable information of the example embodiments of the present disclosure can also be data information from a database, wherein the data information and data specification information are maintained by different maintenance users; if the target data is data of data information type, the target user of the target collaborative user device is data information maintenance user, and the data information matches the data structure and data content contained in the editable information. First, a data access interface is established between the data management platform and the collaborative user device, and data transmission is performed based on the data access interface. Based thereon, the data management platform obtains the data information in the database and the data specification information in the collaborative user device based on the data access interface, and matches the data information of the database with the data specification information. If the data information of database does not match the data specification information of the target collaborative user device, it is determined that the matching result is abnormal, and the target data is determined based on the abnormal information of the matching result.

After determining that the data content in the database contains abnormal target data, the data management tool sends a target data modification message to the maintenance user of the target data, and the maintenance user modifies the data information in the database based on the target data modification message. The target data modification message can be a message prompting the maintenance user to change the target data, or a message prompting the maintenance user to complete the target data.

When the target data comes from the data specification information in the collaborative user device, after determining the target data, the data management tool sends the target data modification message to the maintenance user of the target data, and the maintenance user modifies the data specification information in the collaborative user device based on the target data modification message.

In an optional manner, the data management tool of the example embodiments of the present disclosure may, in response to an update message of the editable information, determine to send an update indication of the target data to the collaborative user device based on the update message of the target data. The update indication of the target data is used to instruct the collaborative user device to display the editable information.

When the editable information includes editable shared information from the collaborative user device, the update message of the target data essentially received by the data management tool may include an update message from the editable shared information, that is, modification information of the editable shared document uploaded by the collaborative user device. When the editable information includes data information from the database, the update message of the target data includes the database table blood relationship update information from the database.

Taking the target data update in the database as an example, the data management tool obtains the update message of the target data from the database. The update message of the target data may be a regenerated database table blood relationship. The data management tool sends an update indication to the collaborative user device based on an update message of the target data, where the message update indication is used to instruct the collaborative user device to display the data update information of the editable information. After the maintenance user modifies the target data included in the data content in the database based on the target data modification message, the data management tool sends an update message of the database table blood relationship to the collaborative user device.

In an optional manner, the collaborative user device used in the example embodiments of the present disclosure has a data billboard and a message push window. The data billboard can be accessed through all collaborative user devices or through a specified collaborative user device or may be accessed through a specified maintenance user to display the data information of the database and the update prompt of the target data in the data specification information from the data management platform and display the update content of the target data. Corresponding to the update of the target data, a data update prompt or data update content is pushed to all collaborative user devices or specified collaborative user device based on the message push window function.

The example embodiments of the present disclosure integrate data filling work into daily life based on editable information, and divide the data work based on users with different roles. Users with different roles are only responsible for the maintenance of their own data content. Data changes are detected through the data management platform, and the data in the database is updated. The transitive working method based on the waterfall process is converted to a small iterative working method driven by background events, with each link circulating on its own. Therefore, the work efficiency is improved, and the functions of data products can still be maintained while reducing data products.

Based thereon, the example embodiments of the present disclosure replace data management products with online documents, and replace centralized data management models with decentralized daily task models. For example, from the perspective of documents, tasks, reminders and messages in the daily work, the relevant elements of the master data are extracted through software programs, so that the functions of the data products can still be maintained after reducing the data products. And integrated with the collaborative work platform, data is managed use online documents, data management is decentralized to various departments that maintain different data, and software products are responsible for identifying, delivering and tracking data change events, so that the work of each business changes from a dependency to a self-cycling approach. Based thereon, it is possible to reduce the understanding and learning of data management technical users in other aspects, focus on data processing and improve the efficiency of data management, and change the two-way working mode of business and technology into a multi-directional collaborative working mode, which not only improves the collaboration office efficiency but also enhances the data usage efficiency.

With one or more technical solutions provided in the example embodiments of the present disclosure, if it is detected that the data specification information does not match the target data included in the editable information, the target data modification message is pushed to the target collaborative user device, so as to cause the target user to modify the target data through the target collaborative user device. The target data modification message includes the locating information of the target data, and the target collaborative user device is determined by the locating information. Therefore, the maintenance user of the target data can obtain the target data modification message through the target collaborative user device in a timely manner, and then modify the target based on the target data modification message. data. The editable information includes editable shared information from a plurality of collaborative user devices; the editable shared information includes data structures and data contents maintained by different maintenance users. If the target data is data of data structure type, the target user of the target collaborative user device is a data structure maintenance user; if the target data is data of data content type, the target user of the target collaborative user device is a data structure maintenance user. Based thereon, the time required in the information transfer process can be reduced, collaboration efficiency improved, and data accuracy guaranteed.

The solutions provided by the embodiments of the present disclosure have been introduced mainly from the perspective of interaction between the terminal and the server. It can be understood that, in order to implement the above functions, the terminal and server include corresponding hardware structures and/or software modules to perform each function. Those skilled in the art should easily realize that the present disclosure can be implemented in the form of hardware or a combination of hardware and computer software in conjunction with the units and algorithm steps of each example described in the embodiments disclosed herein. Whether a certain function is performed by hardware or computer software driving the hardware depends on the specific application and design constraints of the technical solution. For each particular application, technically skilled users may implement the described functionality using different methods, but such implementations should not be considered to exceed the scope of the present disclosure.

The embodiments of the present disclosure can divide the terminal and the server into functional units according to the above method examples. For example, each functional module can be divided corresponding to each function, or two or more functions can be integrated into one processing module. The above integrated modules can be implemented in the form of hardware or software function modules. It is noteworthy that the division of modules in the embodiments of the present disclosure is schematic and is only a logical function division, and other division methods may exist in actual implementation.

In the event of dividing each functional module corresponding to each function, the example embodiments of the present disclosure provide an apparatus of data management. FIG. 5 shows a schematic block diagram of modules of an apparatus of data management according to an example embodiment of the present disclosure. As shown in FIG. 5, the apparatus 500 comprises:
a determining module 501 configured for, in accordance with a determination that data specification information does not match target data comprised in editable information, determining a target data modification message; and
a pushing module 502 configured for pushing the target data modification message to a target collaborative user device, so as to cause a target user to modify the target data through the target collaborative user device; wherein the target data modification message comprises locating information of the target data, and the target collaborative user device is determined based on the locating information; the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data structure maintenance user.

As a possible implementation, the apparatus 500 further comprises a obtaining module 503 configured for obtaining data specification information from at least one collaborative user device, and a user of the collaborative user device is a data specification information maintenance user.

As a possible implementation, the data specification information at least comprises a data structure specification. The determining module 501 is also configured for: obtaining a data structure matching result by matching a data structure of the editable information and the data structure specification; and in accordance with a determination that the data structure matching result is abnormal, determining the target data based on the data structure matching result.

As a possible implementation, the data specification information is data specification programming information. The data specification information further comprises a data content specification. The determining module 501 is also configured for: obtaining a data content matching result by matching a data content of the editable information and the data content specification; and in accordance with a determination that the data content matching result is abnormal, determining the target data based on the data content matching result.

As a possible implementation, the data specification information is data specification programming information. The determining module 501 is also configured for: in accordance with a determination that a data content specification of the data specification information does not match a predetermined data content specification, determining matching result abnormal information, and determining target data contained in the data content of the data specification information based on the matching result abnormal information; or in accordance with a determination that a programming language specification of the data specification programming information does not match a reference programming language, determining the matching result abnormal information, and determining target data contained in the programming language of the data specification information based on the matching result abnormal information.

As a possible implementation, determining the target data modification message based on the target data comprises: determining abnormal information of the target data based on the target data; and determining the target data modification message based on the abnormal information of the target data.

As a possible implementation, the target data modification message further comprises a modification prompt of the target data, and the modification prompt is determined based on the abnormal information.

As a possible implementation, the editable information comprises data information from a database, and the data information and the data specification information are maintained by different maintenance users; if the target data is data of the data information type, the target user of the target collaborative user device is a data information maintenance user, and the data information matches the data structure and the data content.

As a possible implementation, in response to an update message of the editable information, determining, based on an update message of the target data, that an update indication of the target data is to be sent to the collaborative user device, the update indication of the target data being for instructing the collaborative user device to display the update message of the editable information.

As a possible implementation, the editable information comprises editable shared information from a collaborative user device, and the update message of the target data comprises an update message from the editable shared information; and/or the editable information comprises data information from a database, and the update message of the target data comprises database table hierarchical relationship update information from the database.

FIG. 6 shows a schematic block diagram of a chip according to an example embodiment of the present disclosure. As shown in FIG. 6, the chip 600 comprises one or more (including two) processors 601 and a communication interface 602.

In one example, the communication interface 602 can support the data management platform to perform the data sending and receiving steps in the above method, and the processor 601 can support tools to perform the data processing steps in the above method.

In another example, the communication interface 602 can support the collaborative user device to perform the data sending and receiving steps in the above method, and the processor 601 can support the collaborative user device to perform the data processing steps in the above method.

Optionally, as shown in FIG. 6, the chip 600 further comprises a memory 603. The memory 603 may include a read-only memory and a random access memory, and provide operating instructions and data to the processor. Part of the memory may also include a non-volatile random access memory (NVRAM).

In some implementations, as shown in FIG. 6, the processor 601 performs corresponding operations by calling operating instructions stored in the memory (the operating instructions may be stored in an operating system). The processor 601 controls any of the processing operations in the terminal device. The processor may further be called a central processing unit (CPU). The memory 603 may include a read-only memory and a random access memory and provide instructions and data to the processor 601. Part of the memory 603 may further include NVRAM. For example, in an application, the memory, communication interface and memory are coupled together through a bus system. In addition to a data bus, the bus system may further include a power bus, a control bus, a status signal bus, etc. However, for the sake of clarity, the various buses are labeled as a bus system 604 in FIG. 6.

The methods disclosed in the above embodiments of the present disclosure may be applied in the processor or implemented by the processor. The processor may be an integrated circuit chip that has signal processing capabilities. During the implementation process, each step of the above method may be completed by instructions in the form of hardware integrated logic circuits or software in the processor. The above-mentioned processor may be a general-purpose processor, a digital signal processor (DSP), an ASIC, a field-programmable gate array (FPGA) or other programmable logic device, discrete gate or a transistor logic device or a discrete hardware component. The disclosed methods, steps and logical block diagrams in the embodiments of the present disclosure may be implemented or executed. The general-purpose processor may be a microprocessor or the processor may be any conventional processor, etc. The steps of the method disclosed in combination with the embodiments of the present disclosure may be directly implemented by a hardware decoding processor, or may be executed by a combination of hardware and software modules in the decoding processor. The software module can be located in a random access memory, a flash memory, a read-only memory, a programmable read-only memory or an electrically erasable programmable memory, a register and other mature storage media in the art. The storage medium is located in a memory, and the processor reads information in the memory and completes the steps of the above method in combination with its hardware.

The example embodiments of the present disclosure further provide an electronic device, comprising: at least one processor; and a memory communicatively connected with the at least one processor. The memory stores a computer program which can be executed by the at least one processor, and when executed by the at least one processor, the computer program is used to cause the electronic device to perform the method according to the embodiments of the present disclosure.

The example embodiments of the present disclosure further provide a non-transient computer-readable storage medium storing a computer program thereon, wherein the computer program, when executed by a processor of a computer, is used to cause the computer to perform the method according to the embodiments of the present disclosure.

The example embodiments of the present disclosure further provide a computer program product, comprising a computer program, wherein the computer program, when executed by a processor of a computer, is used to cause the computer to perform the method according to the embodiments of the present disclosure.

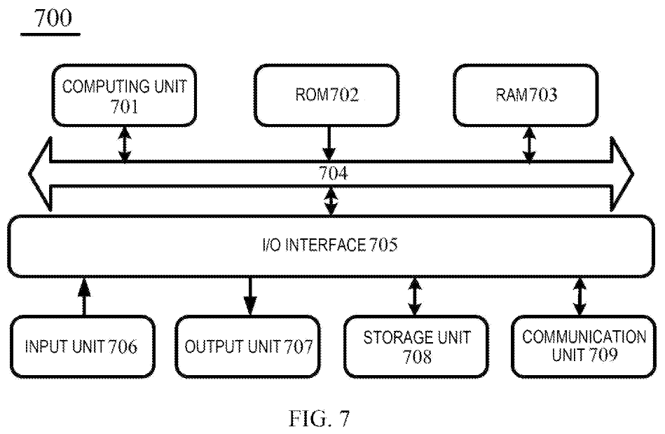

Referring to FIG. 7, a structural block diagram of an electronic device 700 that may serve as a server or client of the present disclosure will now be described as an example of a hardware device which may be applied to aspects of the present disclosure. Electronic devices are intended to refer to various forms of digital electronic computer devices, such as laptop computers, desktop computers, workstations, personal digital assistants, servers, blade servers, mainframe computers, and other suitable computers. Electronic devices may further represent various forms of mobile devices, such as personal digital assistants, cellular phones, smart phones, wearable devices, and other similar computing devices. The components shown herein, their connections and relationships, and their functions are examples only and are not intended to limit implementations of the present disclosure described and/or claimed herein.

As shown in FIG. 7, the electronic device 700 comprises a computing unit 701 which is capable of performing various appropriate actions and processes in accordance with computer programs stored in a read only memory (ROM) 7022 or computer programs loaded from a storage unit 707 to a random access memory (RAM) 703. In the RAM 703, there are also stored various programs and data required by the electronic device 700 when operating. The processing unit 701, the ROM 702 and the RAM 703 are connected to one another via a bus 704. An input/output (I/O) interface 705 is also connected to the bus 704.

A plurality of components in the electronic device 700 may be connected to the I/O interface 705: an input unit 706, an output unit 707, a storage unit 708 and a communication unit 709. The input unit 706 may be any type of device capable of inputting information to the electronic device 700. The input unit 706 may receive input numeric or character information and generate key signal inputs related to user settings and/or function control of the electronic device. The output unit 707 may be any type of device capable of presenting information, and may include, but is not limited to, a display, a speaker, a video/audio output terminal, a vibrator, and/or a printer. The storage unit 708 may include, but is not limited to, a magnetic disk or an optical disk. The communication unit 709 allows the electronic device 700 to exchange information/data with other devices through a computer network such as the Internet and/or various telecommunications networks, and may include, but is not limited to, a modem, a network card, an infrared communication device, a wireless communication transceiver and/or a chip group such as Bluetooth™ devices, WiFi devices, WiMax devices, cellular communications devices and/or the like.

As shown in FIG. 7, the computing unit 701 may be a variety of general and/or special purpose processing components with processing and computing capabilities. Some examples of the computing unit 701 include, but are not limited to, a central processing unit (CPU), a graphics processing unit (GPU), various dedicated artificial intelligence (AI) computing chips, various computing units that run machine learning model algorithms, a digital signal processing processor (DSP), and any appropriate processor, controller, microcontroller, etc. The computing unit 701 performs the various methods and processes described above. For example, in some embodiments, the methods of the example embodiments of the present disclosure may be implemented as a computer software program which is tangibly embodied in a machine-readable medium, e.g., the storage unit 708. In some embodiments, part or all of the computer program may be loaded and/or installed onto the electronic device 700 via the ROM 702 and/or the communication unit 709. In some embodiments, the computing unit 701 may be configured to perform a method in any other suitable manner (e.g., by means of firmware).

Program codes for implementing the methods of the present disclosure may be written in any combination of one or more programming languages. These program codes may be provided to a processor or controller of a general-purpose computer, special-purpose computer, or other programmable data processing device, such that the program codes, when executed by the processor or controller, cause the functions/operations specified in the flowcharts and/or block diagrams to be implemented. The program code may be entirely or partly executed on the machine, or as a stand-alone software package, partly on the machine and partly on a remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatuses or devices, or any suitable combination of the foregoing. More specific examples of machine-readable storage media would include one or more wires based electrical connection, portable computer disk, hard drive, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

As used herein, the terms “machine-readable medium” and “computer-readable medium” refer to any computer program product, device, and/or apparatus for providing machine instructions and/or data to a programmable processor (e.g., magnetic disk, optical disk, memory, programmable logic device (PLD)), including machine-readable media that receive machine instructions as machine-readable signals. The term “machine-readable signal”” refers to any signal used to provide machine instructions and/or data to a programmable processor.

To provide interaction with a user, the systems and techniques described herein may be implemented on a computer having: a display device (e.g., a CRT (cathode ray tube) or LCD (liquid crystal display) monitor) for displaying information to the user; and a keyboard and pointing device (e.g., a mouse or a trackball) through which the user may provide inputs to the computer. Other kinds of devices may further be used to provide interaction with the user; for example, the feedback provided to the user may be any form of sensory feedback (e.g., visual feedback, auditory feedback, or tactile feedback); and may be provided in any form (including acoustic inputs, speech inputs, or tactile inputs) to receive inputs from the user.

The systems and techniques described herein may be implemented in a computing system that includes background components (e.g., as a data server), or a computing system that includes middleware components (e.g., an application server), or a computing system that includes front-end components (e.g., a user s computer having a graphical user interface or web browser through which the user can interact with implementations of the systems and technologies described herein), or a computing system including any combination of such background components, middleware components, and front-end components. The components of the system may be interconnected by any form or medium of digital data communication (e.g., a communications network). Examples of communication networks include: local area networks (LAN), wide area networks (WAN), and the Internet.

Computer systems may include clients and servers. Clients and servers are generally remote from each other and typically interact over a communications network. The client and server relationship is generated by computer programs running on corresponding computers and having a client-server relationship with each other.

The above embodiments may be implemented in whole or in part by software, hardware, firmware, or any combination thereof. When implemented using software, it may be implemented in whole or in part in the form of a computer program product. The computer program product includes one or more computer programs or instructions. When the computer program or instructions are loaded and executed on a computer, the processes or functions described in the embodiments of the present disclosure are performed in whole or in part. The computer may be a general-purpose computer, a special-purpose computer, a computer network, a terminal, a user device, or other programmable device. The computer program or instructions may be stored in a computer-readable storage medium or transmitted from one computer-readable storage medium to another. For example, the computer program or instructions may be transmitted from a website, computer, server or data center to another website site, computer, server, or data center in a wired or wireless manner. The computer-readable storage medium may be any available medium that can be accessed by a computer or a data storage device such as a server or data center that integrates one or more available media. The available media may be magnetic media, such as floppy disks, hard disks, and magnetic tapes; or optical media, such as digital video discs (DVDs); or semiconductor media, such as solid state drives (SSDs).

Although the present disclosure has been described in conjunction with specific features and embodiments thereof, it will be apparent that various modifications and combinations may be made without departing from the spirit and scope of the disclosure. Accordingly, the specification and drawings are merely example illustration of the disclosure as defined by the appended claims and are deemed to cover any and all modifications, variations, combinations, or equivalents within the scope of the disclosure. Obviously, those skilled in the art can make various changes and variations to the present disclosure without departing from the spirit and scope of the disclosure. In this way, if these modifications and variations of the present disclosure fall within the scope of the claims of the present disclosure and equivalent technologies, the present disclosure is also intended to include these modifications and variations.

What is claimed is:

1. A method of data management, comprising:
in accordance with a determination that data specification information does not match target data comprised in editable information, determining a target data modification message; and
pushing the target data modification message to a target collaborative user device, so as to cause a target user to modify the target data through the target collaborative user device;
wherein the target data modification message comprises locating information of the target data, and the target collaborative user device is determined based on the locating information;
the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data content maintenance user.

2. The method of claim 1, further comprising: obtaining data specification information from at least one collaborative user device, and a user of the collaborative user device is a data specification information maintenance user.

3. The method of claim 1, wherein the data specification information at least comprises a data structure specification, and the method further comprises:
obtaining a data structure matching result by matching a data structure of the editable information and the data structure specification; and
in accordance with a determination that the data structure matching result is abnormal, determining the target data based on the data structure matching result.

4. The method of claim 1, wherein the data specification information further comprises a data content specification, and the method further comprises:
obtaining a data content matching result by matching a data content of the editable information and the data content specification; and
in accordance with a determination that the data content matching result is abnormal, determining the target data based on the data content matching result.

5. The method of claim 1, wherein the data specification information is data specification programming information, and the method further comprises:
in accordance with a determination that a data content specification of the data specification information does not match a predetermined data content specification, determining matching result abnormal information, and determining target data contained in the data content of the data specification information based on the matching result abnormal information; or
in accordance with a determination that a programming language specification of the data specification programming information does not match a reference programming language, determining the matching result abnormal information, and determining target data contained in the programming language of the data specification information based on the matching result abnormal information.

6. The method of claim 1, wherein determining the target data modification message comprises:
determining abnormal information of the target data based on the target data; and
determining the target data modification message based on the abnormal information of the target data.

7. The method of claim 6, wherein the target data modification message further comprises a modification prompt of the target data, and the modification prompt is determined based on the abnormal information.

8. The method of claim 1, wherein the editable information comprises data information from a database, and the data information and the data specification information are maintained by different maintenance users; if the target data is data of the data information type, the target user of the target collaborative user device is a data information maintenance user, and the data information matches the data structure and the data content.

9. The method of claim 1, further comprising:
in response to an update message of the editable information, determining, based on an update message of the target data, that an update indication of the target data is to be sent to the collaborative user device, the update indication of the target data being for instructing the collaborative user device to display the update message of the editable information.

10. The method of claim 9, wherein the editable information comprises editable shared information from a collaborative user device, and the update message of the target data comprises an update message from the editable shared information; and/or
the editable information comprises data information from a database, and the update message of the target data comprises database table hierarchical relationship update information from the database.

11. An electronic device, comprising:
a processor; and
a memory for storing a program;
wherein the program comprises instructions, which, when executed by the processor, cause the processor to perform acts comprising:
in accordance with a determination that data specification information does not match target data comprised in editable information, determining a target data modification message; and
pushing the target data modification message to a target collaborative user device, so as to cause a target user to modify the target data through the target collaborative user device;
wherein the target data modification message comprises locating information of the target data, and the target collaborative user device is determined based on the locating information;
the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data content maintenance user.

12. The electronic device of claim 11, wherein the acts further comprises:
obtaining data specification information from at least one collaborative user device, and a user of the collaborative user device is a data specification information maintenance user.

13. The electronic device of claim 11, wherein the data specification information at least comprises a data structure specification, and the acts further comprises:
obtaining a data structure matching result by matching a data structure of the editable information and the data structure specification; and
in accordance with a determination that the data structure matching result is abnormal, determining the target data based on the data structure matching result.

14. The electronic device of claim 11, wherein the data specification information further comprises a data content specification, and the acts further comprises:
obtaining a data content matching result by matching a data content of the editable information and the data content specification; and
in accordance with a determination that the data content matching result is abnormal, determining the target data based on the data content matching result.

15. The electronic device of claim 11, wherein the data specification information is data specification programming information, and the acts further comprises:
in accordance with a determination that a data content specification of the data specification information does not match a predetermined data content specification, determining matching result abnormal information, and determining target data contained in the data content of the data specification information based on the matching result abnormal information; or
in accordance with a determination that a programming language specification of the data specification programming information does not match a reference programming language, determining the matching result abnormal information, and determining target data contained in the programming language of the data specification information based on the matching result abnormal information.

16. The electronic device of claim 11, wherein determining the target data modification message comprises:
determining abnormal information of the target data based on the target data; and
determining the target data modification message based on the abnormal information of the target data.

17. The electronic device of claim 16, wherein the target data modification message further comprises a modification prompt of the target data, and the modification prompt is determined based on the abnormal information.

18. The electronic device of claim 11, wherein the editable information comprises data information from a database, and the data information and the data specification information are maintained by different maintenance users; if the target data is data of the data information type, the target user of the target collaborative user device is a data information maintenance user, and the data information matches the data structure and the data content.

19. The electronic device of claim 11, wherein the acts further comprises:
in response to an update message of the editable information, determining, based on an update message of the target data, that an update indication of the target data is to be sent to the collaborative user device, the update indication of the target data being for instructing the collaborative user device to display the update message of the editable information.

20. A non-transient computer-readable storage medium storing computer instructions thereon, wherein the computer instructions are configured for causing the computer to perform acts comprising:
in accordance with a determination that data specification information does not match target data comprised in editable information, determining a target data modification message; and
pushing the target data modification message to a target collaborative user device, so as to cause a target user to modify the target data through the target collaborative user device;
wherein the target data modification message comprises locating information of the target data, and the target collaborative user device is determined based on the locating information;
the editable information comprises editable shared information of a plurality of collaborative user devices; the editable shared information comprises a data structure and data content maintained by different maintenance users, and if the target data is data of data structure type, the target user of the target collaborative user device is a data structure maintenance user; if the target data is data of data content type, the target user of the target collaborative user device is a data content maintenance user.
